(19) United States
(12) Patent Application Publication
(10) Pub. No.: US 2007/0130597 A1
(43) Pub. Date: Jun. 7, 2007

(54) Network based instant replay and time shifted playback

(75) Inventors: Alistair John Parker, Quispamsis (CA); Jeff Furlong, Grand Bay-Westfield (CA); Gino Louis Dion, McKinney, TX (US); Sean Gordon Higgins, Saint John (CA)

Correspondence Address: KRAMER & AMADO, P.C., 1725 DUKE STREET, SUITE 240, ALEXANDRIA, VA, 22314, US

(73) Assignee: Alcatel, Paris (FR)

(21) Appl. No.: 11/292,345

(22) Filed: Dec. 2, 2005

(51) Int. Cl. H04N 7/173

(52) U.S. Cl. 725/94; 725/115; 725/114; 725/96

(57) ABSTRACT

A circular buffer in a video delivery server tracks a second copy of a live video stream to provide instant replay capability. When an end-user initiates the instant replay function, the circular buffer is copied to an instant-replay buffer, from which a replay of the video is sent to the end-user. During replay the end-user can use playback functions such as pause, slow-play, freeze frame, etc. Upon leaving the replay function the end user rejoins the live stream. The circular buffer also enables transmission of delayed copies of the live stream, time-shifted by predetermined intervals, which copies are multicasted to end-users. Upon request, an end-user may join a delayed version of interest. This allows the user to replay interesting content by jumping to a time-delayed version without missing the show and to catch up with real-time during e.g. commercial breaks.

### FIELD OF THE INVENTION

The invention is directed to communication networks and in particular to a multimedia delivery system with instant replay and time-shifted playback.

### BACKGROUND OF THE INVENTION

Systems for delivering broadcast television over the Internet Protocol are emerging, along with new services that enhance and diversify the entertainment experience of subscribers to such systems. Generally, a broadcast provider obtains multimedia signals (e.g. TV signals) from traditional sources such as satellite or cable and encodes the signals for delivery to subscribers over an IP enabled broadband network. Subscribers enabled with television sets and set top boxes (STB) or PCs are fitted with appropriate software to decode the respective IP format for program viewing. An interactive electronic program guide, viewable on the subscriber's monitor or TV, provides access to a range of viewing features and system management functions.

Currently, program delivery and the services available to the subscribers are at the convenience of the service provider or broadcaster and, hence, the subscriber must arrange his/her schedule to coincide with program availability. On the other hand, because of the proliferation of broadband backbone and delivery networks, emergence of specialty services (such as pay per view and first run movies), and increase in usage of PCs by consumers, an increasing demand is evolving for on-demand multimedia services. These services enable consumers to plan their entertainment to their own schedule and interests rather than tailor their entertainment viewing habits to a service provider's broadcast schedule.

The service providers use unicast and multicast protocols to deliver their services to subscribers. Multicast protocols are used for conventional TV programming and near video on demand (NVOD) movie selections, as they enable numerous subscribers to have access to a program at the same time. Unicast IP protocols are preferably used for true video-on-demand services such as VOD, VDVR, timelessTV and TV-on-Demand.

Currently, subscribers viewing a multicast stream cannot freely interrupt the stream to review content previously delivered, because there are other viewers joined to the same transport stream. Subscribers must actively store and manage the broadcast content for the purposes of instant-replay and time-shifted playback. In recent years, one popular approach to offer some form of VCR-like interactivity is to add a storage unit to the subscriber equipment so as to cache all the available content being broadcast. Many time-shifted systems that exist today are based on having the clients record in real-time a channel of interest; only by this means can the content be played back.

For example, TiVo™ set top boxes (STB) available today function similarly to VCRs, but use non-removable hard-disk storage, and contain sophisticated software to record programs—not only those the user specifically requests, but also other material the user is likely to be interested in. Programs being watched “live” can be paused or “rewound” to repeat a sequence just watched. A TiVo digital video recorder (DVR) allows a user to specify which programs to record by time, by program title, and by specifying combinations of genre, actors, directors, etc. Programs may be stored until internal storage is filled, at which time the unit will dispose of older programs (unless flagged to be saved until manually deleted), to allow for new programs to be recorded.

However, standalone TiVo systems can only record one channel at a time. In addition, “time-shifted playback” in order to view/review a certain past content, can be performed only for the channels currently viewed. Furthermore, TiVo requires special hardware (hard drive) in the STB to enable this feature, which is costly, and suffers from operational problems like storage unit failure and management.

For example, US Patent Application Publication # 20030170003 entitled “Time-Shifted Video Signal Processing” (Levesque et al.) describes a time-shifted playback method where real-time video frames are delivered for display during a real-time mode, and time-shifted video frames are delivered for display during a time-shifted mode. The time-shifted video frames are delayed relative to the real-time video frames. A real-time frame is paused during a transition from the real-time mode to the time-shifted mode. This method enables a client-side implementation of trick play and instant replay.

Most “time-shifted” viewing offered by digital providers is purely based on TV networks broadcasting in different time-zones, letting you watch e.g. the 18:00 clock news in Vancouver at the 21:00 Toronto time.

There are also some entertainment delivery systems that use network storage devices for providing instant-replay and time-shifted playback, as described in e.g. US Patent Application Publication # 20040254999 entitled “System For Providing Content To Multiple Users” (Bulleit et al). The delivery system described by Bulleit et al. comprises a grid computing platform, which provides storage of the content across network storage devices and consumer storage devices. The grid computing platform monitors distribution of the content to one or more of the consumer networks and determines when and where to store non-real time video. Processor-based network element(s) determine, based on customer preference, customer viewing habits or other factors, when to store a video program on the consumer storage device and where to store content that is not resident on the user's local consumer storage device. This is a very complex system and as such is prone to errors and expensive.

An example of a combination of network DVR and download VOD is presented in the U.S. Pat. No. 6,611,654 entitled “Time- and location-driven personalized TV” (Shteyn). This patent describes a server system that enables a subscriber to select a specific broadcast program for recording and a specific location and time frame for play-out of the recorded program. In one embodiment, the content information can be recorded at a first recording system, e.g., at a server. The selected content information recorded on the recording system can then be streamed over a data network, e.g., over the Internet or a private network like AOL to a location specified by the user. Alternatively, or subsidiarily, a program can be recorded and stored temporarily at a server and then streamed over a data network, e.g., the Internet, using a low-bandwidth protocol, to a recording device specified by the user as destination. Accordingly, the Shteyn's system attempts to contribute to the user's needs by means of enabling shifting of recording and play-out locations, in addition to the time-shifting provided by the known services. The main disadvantage of this system is that it provides an arbitrarily delayed and location-independent experience.

There is a need to enable a subscriber with additional services such as instant replay and time shifted playback that is controllable by the user, does not require expensive subscriber terminals and provides an inexpensive and reliable network solution.

### SUMMARY OF THE INVENTION

It is an object of the invention to provide a simple method for providing a time-shifted view of a live audio/video stream for the purpose of instant-replay review and short-term time-shifting. The implementation of this simple mechanism is transparent to the end-user unless invoked, implying no additional hardware cost or complexity at the STB.

Accordingly, the invention provides, a time-shift unit for a video delivery server for distributing multimedia content streams to a plurality of subscriber premise equipment (SPE) units, where SPE units select and join multimedia content streams using interactive program guide capabilities at the server. The time-shift unit comprises a circular buffer for storing multimedia content received in a live multimedia content stream; a first sender for bypassing the circular buffer and multicasting the live multimedia content stream directly to the SPE units; and a second sender for accessing the multimedia content from a specific position in the circular buffer, and multicasting a time-shifted variant of the live multimedia content stream to the SPE units, wherein the specific position in the circular buffer confers a predetermined time-shift for the variant of the live multimedia content stream with respect to the live multimedia content stream.

Further, the invention also provides the video server with an instant reply unit comprising: a replay buffer for storing a length T of multimedia content; an instant replay controller for receiving an instant reply request from the CPE unit, taking a snapshot copy of length T of the multimedia content from the circular buffer to the reply buffer and directing a pointer associated with the SPE unit to the reply buffer; and a sender associated with the replay buffer for transmitting the snapshot copy to the SPE unit from the reply buffer.

The invention also provides a for distributing multimedia content streams to a plurality of subscriber premise equipment (SPE) units, where SPE units select and join multimedia content streams using interactive program guide capabilities at the server, comprising: continuously storing multimedia content received in a live multimedia content stream into a circular buffer; identifying a specific access point in the circular buffer that provides a predetermined time-shift of multimedia content in the circular buffer from the access point of multimedia content in the live multimedia content stream; and accessing the multimedia content from the specific offset in the circular buffer, and multicasting a time-shifted variant of the live multimedia content stream to the SPE units from the specific access point.

The method of distributing multimedia content streams further comprises: providing a plurality of reply buffers of various lengths Tn; receiving an instant reply request from the CPE unit, wherein the instant reply specifies a length T for instant reply of selected content of interest; identifying a certain reply buffer from the plurality of reply buffers that can store content of the length T; taking a snapshot copy of length T of the multimedia content from the circular buffer to the certain reply buffer and directing a pointer associated with the SPE unit to the certain reply buffer; and transmitting the instant reply content of interest to the SPE unit.

Instant replay and time-shifted playback would likely be considered as mandatory features for IPTV users. Advantageously, the invention provides a network implementation of instant-replay and time-shifted playback, while enabling the subscriber with a VCR-like functionality for any multimedia (TV) broadcast program. This enables reduced complexity in the equipment located at the subscriber premises, since the STB will need less memory. Therefore the present solution enables implementing these additional features more cost-effectively in the network compared to traditional client-side implementations.

Since it is implemented in the network, the system according to the invention permits real-time statistical reporting so that the service providers can further adapt their offerings to subscribers' needs. In addition, the system is client-agnostic, in that it does not require any special custom hardware and only minimal software changes.

### BRIEF DESCRIPTION OF THE DRAWINGS

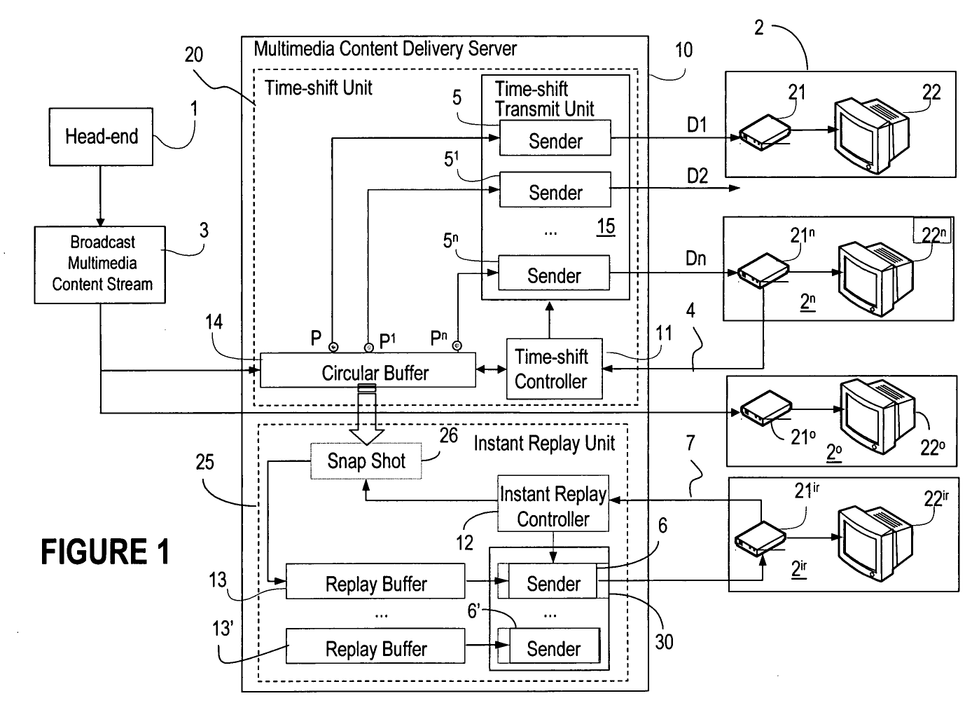

The foregoing and other objects, features and advantages of the invention will be apparent from the following more particular description of the preferred embodiments, as illustrated in the appended drawing FIG. 1, which illustrates mapping between services, network infrastructure and functionality.

### DETAILED DESCRIPTION

Definition of some terms is provided for better understanding the invention. The term “instant replay” refers to a feature that enables a viewer of a TV program/channel to jump back in time by a few seconds (8-10 seconds), and resume viewing of the respective channels from that point in time. The term “time-shifted playback” refers to a feature that enables a viewer to switch from one version of the TV signal to another version which is delayed or ahead of the previous version by a specified amount of time. This can be used to effectively rewind the signal when real-time viewing is interrupted (e.g. whilst speaking on the phone, or while answering the door) and to fast-forward the signal subsequently. The term “trick play” refers to using controls such as pause, instant replay, rewind, fast forward, slow, skip to end, while watching live TV.

The term “multimedia content” is used here to designate units of information (packets, frames, etc) transported by the multimedia content streams according to the respective transport protocol.

FIG. 1 illustrates a video delivery system 10 enabled with instant-replay and time-shifted playback according to the invention. It is noted that only the parts relevant to the invention are illustrated in FIG. 1, and that the units enabling unrelated functionality are not shown for system 10. In principle, system 10 offers broadcast television over Internet Protocol (IP), including IP multicast and unicast, and offers subscribers control for channel browsing, selection and retrieval of the selected program (interactive program guide capabilities).

For large amounts of data, including point-to-multipoint (P2P) video transmissions, IP multicast is more efficient than normal Internet unicast transmissions because a server can broadcast the multimedia content to many recipients simultaneously. Unlike traditional Internet traffic that requires separate connections for each source-destination pair, IP multicasting allows many recipients to share the same source. This means that just one set of packets is required to be transmitted for all the destinations, and that the clients join the multicast stream upon request.

As well known, the subscriber premise equipment SPE (or subscriber terminal, or user terminal, or end-client) denoted with 2, 2ⁿ, 2^{o}, 2^{ir}, may include a set-top box (STB) 21, 21ⁿ, 21^{o}, 21^{ir}, and a TV monitor 22, 22ⁿ, 22^{o}, 22^{ir}, respectively, for enabling a subscriber to view and listen to the multimedia content streamed from system 10. The subscriber terminal is not limited to the examples provided in FIG. 1; as readily understood it may include a personal computer, laptop, notebook, personal assistant, etc. As also known, subscribers use a remote control (not shown) or keyboard/keypad/mouse for interfacing with the interactive program guide (IPG) displayed on the television or computer monitor; the interactive nature of the IPG gives a subscriber control over many aspects of the broadcast system, such as channel browsing, followed eventually by selecting and retrieving the content of the selected program.

Also shown on FIG. 1 is a head end 1 that retrieves multimedia/television/Internet signals broadcast from various sources such as satellites, and converts these signals to one or more IP multicast transport streams which are then sent out to server 10 over a provider network, illustrated in FIG. 1 as broadcast multimedia content streams 3. The live signal is broadcast by server 10 to the SPE's 2, . . . 21ⁿ etc. over any medium (IP, ADSL, ATM, etc.).

Relevant to this invention, server 10 includes a time shift unit 20, and an instant reply unit 25, that provide server 10 with additional functionality by implementing instant-replay and time-shifted playback, for enabling the subscribers with a VCR-like functionality for any multimedia (TV) broadcast program.

Time-shift unit 20 includes a time-shift controller 11, a time-shift transmit unit 15 and a circular buffer 14. Time-shift transmit unit 15 includes a plurality n of senders 5, 5¹, . . . 5ⁿ, for transmitting predefined time shifted variants of the live stream to the SPE's 2, 2¹, . . . 2ⁿ. The circular buffer 14 caches continuously the live stream. Each sender is associated with an access point P, P1, . . . Pⁿ that enables a certain time delay D1 to Dn in rendering the content to the users by sending from a different offset within the circular buffer. The number of senders 5 is a design parameter and is only limited by the amount of memory, CPU and bandwidth available at the server. A STE can choose to view the original live broadcast with any of the available time-shifts (delay) D. For example, in the case that three buffers are used, D1 could be 5 minutes, D2, 15 minutes and D3, 30 minutes. As indicated above, D could have any value desired, memory limited. A variation of this ability is micro time-shifts of 30 seconds, 1 minute, 2 minutes, and 5 minutes. FIG. 1 also illustrates an STE 210 that elected to view the real-time live broadcast with no delay.

In operation, time-shift unit 20 receives a “live” broadcast through a respective medium and continuously caches copies of the live stream in its circular buffer 14. The senders transmit the delayed versions using preferably IP multicast, so that more than one SPE unit can view the same delayed version of the live stream. Upon receipt of a request message 4, let's say from subscriber terminal 21ⁿ, demanding a transmission delayed by Dn, controller 11 identifies the buffer start point Pⁿ for the version time-shifted by Dn, and provides the respective terminal with the address where this stream can be joined. This enables STB 21ⁿ to playback the stream with the respective delay Dn by just joining the appropriate multicast stream (transport medium chosen in this example).

Alternatively, the system may be configured so that the client 2ⁿ can infer what multicast address each of the delayed streams is on, and join the respective stream so that the interaction with controller 11 is optional.

Since it is implemented in the equipment at the edge of the provider's network, the instant replay system of the invention requires fewer resources and is more practical to do in memory, yet is still quite powerful. This configuration of the video delivery system 10 allows subscribers to replay the content of interest by jumping to and from a time-delayed version, to take breaks for answering the phone, and to activate a VCR, etc. without missing the show. It also allows the user to catch-up with real-time during commercial breaks, which are usually even multiples of 30 seconds.

Performance of the time-shifting mechanism described above can be optimized using techniques described in the co-pending U.S. Patent application Ser. No. N/A entitled: “Client Side PID Translation” (Furlong et al.), filed on Nov. 2, 2005. This co-pending Patent Application describes a mechanism whereby program guide and system information is send to subscriber terminals before the respective content. The SPE is provided with an input buffer for storing the input data until a milestone is detected and a multimedia content stream and a system information controller that detects the milestones in the stream. In this way, the decoder does not need to establish the correspondence between the PID of the elementary streams to re-assemble the respective stream upon receipt of the content, since this is performed in advance upon detector initialization. n the case time-shifting is used, the advance knowledge of the decoding information for the respective stream allows the subscriber to perform the time-shift faster than with traditional SPE's.

FIG. 1 also shows an instant replay unit 25 that enables the subscribers with instant replay capabilities. Unit 25 includes an instant reply controller 12, a plurality of arbitrary buffers 13, 13′ and an instant reply transmit unit 30. Buffers 13, 13′ are sized for specific, predetermined amount of information, so that each can store up to Tn seconds of content. For example, buffer 13 may be sized to keep a snap shot of 10 seconds, buffer 13′ may be sized for snap shots of 20 seconds, etc. In this specification, the term “length T” refers to the playback time of the instant replay sequence.

It is to be noted that any number of such buffers may be provided, their number being limited by the memory availability. Instant reply transmit unit 30 comprises senders 6, 6′ that provide the instant reply content to the SPE's 2^{ir}; each sender is associated with a respective buffer 13, 13′.

In operation, when an end-user wants to perform an instant replay function, he/she initiates this event (e.g. a key press on the channel selector), as shown by instant reply request 7. This can be for example implemented using the RTSP (real time streaming protocol), which is a client-server multimedia presentation control protocol, designed to address the needs for efficient delivery of streamed multimedia over IP networks. Once the user initiates the instant replay, controller 12 takes a snapshot copy 26 of the “live” stream from the circular buffer 14 to a certain arbitrary buffer 13 of Tn seconds, and directs a user pointer to it.

At this point sender 6 in this example, commences sending buffer 13 in a continuous loop of 10 seconds (T=10 seconds in this example). With RTSP optional trick play support, the user can pause, fast-forward and rewind the sender within the T second buffer. Once done with the instant-replay, the user may rejoin the live stream. The instant replay stream is sent to STB 21^{ir} preferably as a unicast transmission, since only user 2^{ir} wishes the instant replay at that particular moment.

Performance of the instant replay mechanism described above can be optimized using techniques described in a co-pending U.S. patent application Ser. No. : N/A (Parker et al) entitled “Milestone Synchronization in Broadcast Multimedia Streams” filed on Mar. 28, 2005. This co-pending Patent Application describes a mechanism whereby the beginning of a circular buffer contains the beginning of a GOP sequence (i.e. an MPEG2 I-Frame). This involves flushing data until a GOP sequence is found and keeping track of the PAT/PMT frames separately. As the circular buffers fills-in, the server keeps notes of where the GOP sequences start and end. When a join request arrives from a STE, the requester is added to a list of clients, and the time of request arrival is associated with the closest GOP start in the buffer. Since requests come in randomly, each client is at a specific (different) packet in the buffer. The same circular buffer 14 used for implementing instant reply capabilities may be also used for synchronizing the clients.

We claim:

1. At a video delivery server for distributing multimedia content streams to a plurality of subscriber premise equipment (SPE) units, where SPE units select and join multimedia content streams using interactive program guide capabilities at said server, a time-shift unit comprising:
a circular buffer for storing multimedia content received in a live multimedia content stream;
a first sender for bypassing said circular buffer and multicasting said live multimedia content stream directly to said SPE units; and
a second sender for accessing said multimedia content from a specific position in said circular buffer, and multicasting a time-shifted variant of said live multimedia content stream to said SPE units,
wherein said specific position in said circular buffer confers a predetermined time-shift for said variant of said live multimedia content stream with respect to said live multimedia content stream.

2. The video delivery server of claim 1, further comprising a time-shift controller for receiving a time-shift request message from said SPE unit and providing said SPE unit with a multicast address for said time-shifted variant of said live multimedia content stream.

3. The video delivery server of claim 1, further comprising additional senders for accessing said multimedia content from different specific positions in said circular buffer for providing different predetermined time-shifts Dn, each said additional sender multicasting a respective time-shifted variant of said live multimedia content stream to said SPE units,
wherein a SPE unit selects to join either one of said live multimedia content stream and said time-shifted variants of said multimedia content stream for playback of the content in said live stream directly or with a respective predetermined time-shift Dn.

4. The video delivery server of claim 3, further comprising a time-shift controller for receiving a request message from said SPE unit specifying a preferred time-shift and providing said SPE unit with a respective address enabling said SPE unit to join one of said time-shifted variants of said live multimedia content stream that provides said preferred time-shift.

5. The video delivery server of claim 3, wherein said time-shifts Dn are in the order of tenths of minutes.

6. The video delivery server of claim 3, wherein said time-shifts Dn are in the order of minutes.

7. The video server of claim 1 further comprising an instant reply unit for enabling a SPE unit with instant reply functionality.

8. The video server of claim 7 wherein said instant reply unit comprises:
a replay buffer for storing a length T of multimedia content;
an instant replay controller for receiving an instant reply request from said CPE unit, taking a snapshot copy of length T of the multimedia content from said circular buffer to said reply buffer and directing a pointer associated with said SPE unit to said reply buffer; and
a sender associated with said replay buffer for transmitting said snapshot copy to said SPE unit from said reply buffer.

9. The video server of claim 8 wherein said sender associated with said replay buffer transmits said snapshot copy using a unicast transmission protocol.

10. The video server of claim 8, wherein said length T is in the order of tens of seconds.

11. The video server of claim 8, wherein said instant reply request is implemented using the real time streaming protocol (RTSP).

12. The video server of claim 7 wherein said instant reply unit comprises:
a plurality of replay buffers, each for storing a distinct length Tn of multimedia content;
an instant replay controller for receiving an instant reply request from said CPE unit specifying a preferred length T of an instant replay sequence, taking a snapshot copy of length T of the multimedia content from said circular buffer to one of said reply buffers according to length T; and
a sender associated with said replay buffer selected based on length T for transmitting said snapshot copy of length D to said SPE unit from said reply buffer.

13. A method for distributing multimedia content streams to a plurality of subscriber premise equipment (SPE) units, where SPE units select and join multimedia content streams using interactive program guide capabilities at said server, comprising:
continuously storing multimedia content received in a live multimedia content stream into a circular buffer;
identifying a specific access point in said circular buffer that provides a predetermined time-shift of multimedia content in said circular buffer from the access point of multimedia content in said live multimedia content stream; and
accessing said multimedia content from said specific offset in said circular buffer, and multicasting a time-shifted variant of said live multimedia content stream to said SPE units from said specific access point.

14. The method of claim 13, further comprising bypassing said circular buffer and multicasting said live multimedia content stream directly to said SPE units.

15. The method of claim 13, further comprising receiving a time-shift request message from a SPE unit and providing said SPE unit with a multicast address for said time-shifted variant of said live multimedia content stream.

16. The method of claim 13, further comprising:
identifying additional specific access points in said circular buffer for additional predetermined time-shifts Dn of multimedia content in said circular buffer from the access point of multimedia content in said live multimedia content stream; and
accessing said multimedia content from each said specific access point in said circular buffer, and multicasting additional time-shifted variants of said live multimedia content stream to said SPE units from said additional specific access points.

17. The method of claim 13, further comprising:
receiving an instant reply request from said CPE unit;
taking a snapshot copy of length T of the multimedia content from said circular buffer to a reply buffer and directing a pointer associated with said SPE unit to said reply buffer; and
transmitting said snapshot copy to said SPE unit from said reply buffer.

18. The method of claim 17, wherein said snapshot copy is provided to said SPE unit using a unicast transmission protocol.

19. The method of claim 13, further comprising:
providing a plurality of reply buffers of various lengths Tn;
receiving an instant reply request from said CPE unit, wherein said instant reply specifies a length T for instant reply of selected content of interest;
identifying a certain reply buffer from said plurality of reply buffers that can store content of said length T;
taking a snapshot copy of length T of the multimedia content from said circular buffer to said certain reply buffer and directing a pointer associated with said SPE unit to said certain reply buffer; and
transmitting said instant reply content of interest to said SPE unit.

20. The method of claim 19, further comprising performing trick play operations on said instant reply content of interest in said certain reply buffer.
